(19) United States
(12) Patent Application Publication
(10) Pub. No.: US 2012/0273071 A1
(43) Pub. Date: Nov. 1, 2012

(54) APPLICATION APPARATUS

(75) Inventor: Satoshi Kai, Kawasaki (JP)

(73) Assignee: FUJITSU LIMITED, Kawasaki-shi (JP)

(21) Appl. No.: 13/426,018

(22) Filed: Mar. 21, 2012

(30) Foreign Application Priority Data
Apr. 26, 2011 (JP) 2011-098528

(51) Int. Cl. B01D 47/00

(52) U.S. Cl. 137/565.17

(57) ABSTRACT

An application apparatus includes: a piston including first and second plungers fixed to a shaft; a housing including a fill chamber having an outlet, a control chamber separated from the fill chamber by the first plunger, first and second adjustment chambers separated from each other by the second plunger, and a separation section that separates the control chamber and the first adjustment chamber, the shaft extending moveably through the separation section; a gas supply section to supply a gas into the control chamber, the first adjustment chamber, and the second adjustment chamber; a first valve to control release of the gas within the first adjustment chamber; a second valve to control release of the gas within the second adjustment chamber; and a control section to close the first and second valves and open the first valve to supply the gas into the control chamber and move the piston.

### CROSS-REFERENCE TO RELATED APPLICATION(S)

This application is based upon and claims the benefit of priority of the prior Japanese Patent Application No. 2011-98528, filed on Apr. 26, 2011, the entire contents of which are incorporated herein by reference.

### FIELD

The embodiments discussed herein are related to an application apparatus.

### BACKGROUND

An application apparatus pushes out an application material loaded in a housing having an outlet, and discharges the application material from the outlet. The application apparatus includes a mechanical apparatus in which a piston is driven by an actuator to push out an application material, and a pneumatic apparatus in which a piston is driven by using a pneumatic pressure. The related art is disclosed in, for example, Japanese Laid-open Patent Publication Nos. 2003-47898, 2002-102766, 2000-135465, or Japanese Laid-open Patent Publication No. 10-118546.

### SUMMARY

According to an aspect of the invention, an application apparatus includes: a piston including a first plunger and a second plunger that are fixed to a shaft; a housing including a fill chamber having an outlet, a control chamber separated from the fill chamber by the first plunger, first and second adjustment chambers separated from each other by the second plunger, and a separation section that separates the control chamber and the first adjustment chamber, the shaft extending moveably through the separation section; a gas supply section to supply a gas into the control chamber, the first adjustment chamber, and the second adjustment chamber; a first valve to control release of the gas within the first adjustment chamber; a second valve to control release of the gas within the second adjustment chamber; and a control section to close the first valve and the second valve and open the first valve to supply the gas into the control chamber and move the piston.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary application apparatus;

FIG. 2 illustrates an exemplary nozzle;

FIG. 3 illustrates an exemplary operation of a controller;

FIG. 4 illustrates an exemplary operation of a controller;

FIG. 5 illustrates an exemplary timing chart of a controller;

FIGS. 6A and 6B illustrate an exemplary state of a nozzle;

FIGS. 7A and 7B illustrate an exemplary state of a nozzle;

FIG. 8 illustrates a state of a nozzle; and

FIGS. 9A and 9B illustrate an exemplary discharge state of an application material.

### DESCRIPTION OF EMBODIMENTS

A pneumatic application apparatus includes, for example, a piston, which separates a fill chamber filled with an application material from a control chamber into which air is supplied, in a housing. By supplying air into the control chamber or stopping the supply, the internal pressure of the control chamber increases or decreases and the piston moves or stops.

When air is supplied into the control chamber, the internal pressure of the control chamber increases and the piston receives the pressure and starts moving. The application material loaded in the fill chamber is discharged. When the supply of air into the control chamber is stopped, the internal pressure of the control chamber decreases and the piston stops. The discharge of the application material stops.

From the start of the supply of air into the control chamber to the time when a desired internal pressure of the control chamber is obtained, a certain time period may be taken. During the certain time period, the moving speed of the piston may increase and the discharge amount of the application material may also increase. When the certain time period is long, a desired discharge amount may not be obtained immediately from start of application.

From the stop of the supply of air into the control chamber to the time when a desired internal pressure of the control chamber is obtained, a certain time period may be taken. During the certain time period, the moving speed of the piston may decrease and the discharge amount of the application material may also decrease. When the certain time period is long, the discharge of the application material may not stop immediately from end of application.

When air is used as working fluid for driving the piston, the responsiveness of the piston may deteriorate.

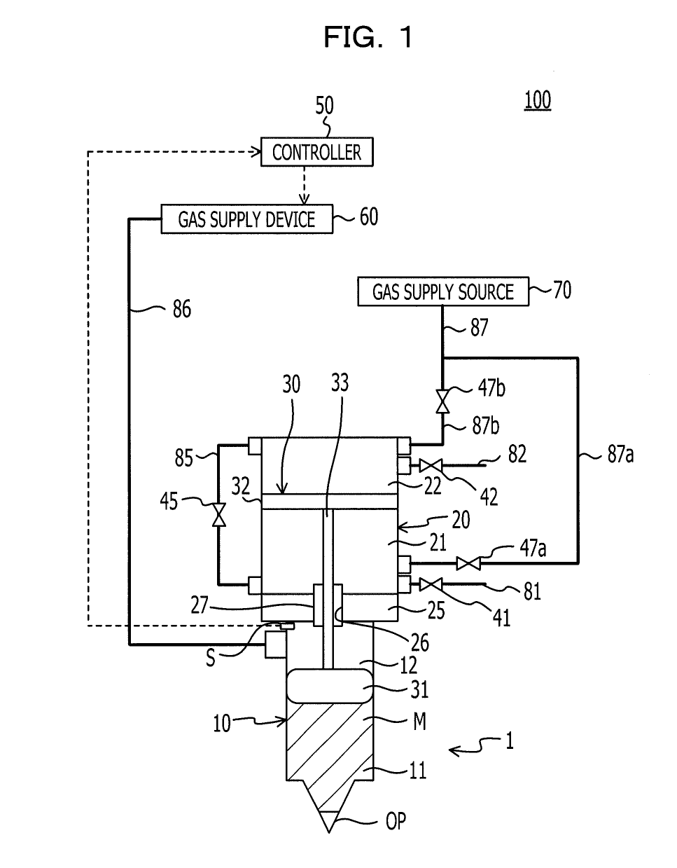

FIG. 1 illustrates an exemplary application apparatus. The application apparatus 100 includes a nozzle 1, a controller 50, a gas supply device 60, and a gas supply source 70. The nozzle 1 includes housings 10 and 20 and a piston 30. The piston 30 includes a shaft 33 and plungers 31 and 32 which are fixed to the shaft 33. The plunger 31 is fixed to a lower end of the shaft 33, and the plunger 32 is fixed to an upper end of the shaft 33. The plunger 31 may correspond to a first plunger. The plunger 32 may correspond to a second plunger. The cross-sectional area of the housing 10 in the axial direction may be smaller than the cross-sectional area of the housing 20 in the axial direction.

The housing 10 includes a fill chamber 11 and a control chamber 12 which are separated from each other by the plunger 31. The fill chamber 11 is filled with an application material M. The application material M may include, for example, an adhesive. At an end of the fill chamber 11, an outlet OP for discharging the application material M may be provided. The fill chamber 11 may correspond to a fill chamber having an outlet for discharging an application material. The control chamber 12 may correspond to a control chamber which is separated from the fill chamber by the first plunger. In the control chamber 12, a sensor S may be provided and outputs to the controller 50 a detection signal based on the pressure in the control chamber 12.

Air is supplied from the gas supply device 60 into the control chamber 12 to control the internal pressure of the control chamber 12. The controller 50 controls an operation of the gas supply device 60. The gas supply device 60 may include, for example, a compressor capable of compressing and transferring air, or a pump. The gas supply device 60 may correspond to a gas supply section capable of supplying air into the control chamber.

The housing 20 includes adjustment chambers 21 and 22 which are separated from each other by the plunger 32. The adjustment chambers 21 and 22 may correspond to first adjustment chamber and second adjustment chamber, respectively, which are separated from each other by the second plunger. The housing 20 includes a separation wall 25. The separation wall 25 separates the control chamber 12 of the housing 10 and the adjustment chamber 21 of the housing 20. In the separation wall 25, a through hole 26 is provided. A cylindrical member 27 is fitted in the through hole 26. The shaft 33 of the piston 30 is engaged with the cylindrical member 27 such that the shaft 30 is moveable upward or downward. The cylindrical member 27 may include, for example, metal. Airtightness is ensured between the adjustment chamber 21 and the control chamber 12, and thus even when the shaft 33 slides in the cylindrical member 27, air may not flow between the adjustment chamber 21 and the control chamber 12. The separation wall 25 may correspond to a separation section that separates the control chamber and the first adjustment chamber and through which a shaft moveably extends. The nozzle 1 includes the fill chamber 11, the control chamber 12, and the adjustment chambers 21 and 22 from the lower side to the upper side in the axial direction.

At the adjustment chambers 21 and 22, tubes 81 and 82 are provided, respectively. On the tubes 81 and 82, valves 41 and 42 are provided, respectively. The controller 50 controls opening and closing of the valves 41 and 42. The valves 41 and 42 may correspond to first and second valves that are capable of releasing air within the first and second adjustment chambers to the outsides of the adjustment chambers, respectively.

The gas supply source 70 supplies air to each of the adjustment chambers 21 and 22. For example, the gas supply source 70 and the adjustment chamber 21 are coupled to each other by a tube 87 coupled to the gas supply source 70 and a tube 87a branching from the tube 87. The gas supply source 70 and the adjustment chamber 22 are coupled to each other by the tube 87 coupled to the gas supply source 70 and a tube 87b branching from the tube 87. Supply valves 47a and 47b are provided on the tubes 87a and 87b, respectively. The gas supply source 70 supplies air into the housing 20 via the tubes 87, 87a, and 87b. The gas supply source 70 may be, for example, a pump.

The controller 50 controls opening and closing of the supply valves 47a and 47b. Since opening and closing of the supply valves 47a and 47b is controlled, the supply of air from the gas supply source 70 into the adjustment chambers 21 and 22 is controlled. The supply valve 47a may correspond to a first supply valve that is controlled by a control section and switches a communication state between the gas supply section and the first adjustment chamber. The supply valve 47b may correspond to a second supply valve that is controlled by the control section and switches a communication state between the gas supply section and the second adjustment chamber.

The gas supply source 70 may supply air into the adjustment chambers 21 and 22 regardless of control of the controller 50. For example, instead of the gas supply source 70, a device may be used in which the supply valves 47a and 47b are not provided and supply of air into the adjustment chambers 21 and 22 is controlled by the controller 50. The gas supply source 70 may correspond to a gas supply section capable of supplying air into the first and second adjustment chambers. Air may be supplied from the same gas supply source 70 into the adjustment chambers 21 and 22, or different gas supply sources may be provided for the adjustment chambers 21 and 22, respectively.

The adjustment chambers 21 and 22 communicate with each other through a tube 85. A communication valve 45 is provided on the tube 85. The controller 50 controls opening and closing of the communication valve 45, and thus communication between the adjustment chambers 21 and 22 is provided or blocked. The communication valve 45 may correspond to a communication valve that is controlled by the control section and capable of providing communication between the first and second adjustment chambers.

The controller 50 controls the valves 41 and 42, the communication valve 45, and the supply valves 47a and 47b and also controls the gas supply device 60. The controller 50 may be a computer which includes a Central Processing Unit (CPU), a Read Only Memory (ROM), or a Random Access Memory (RAM).

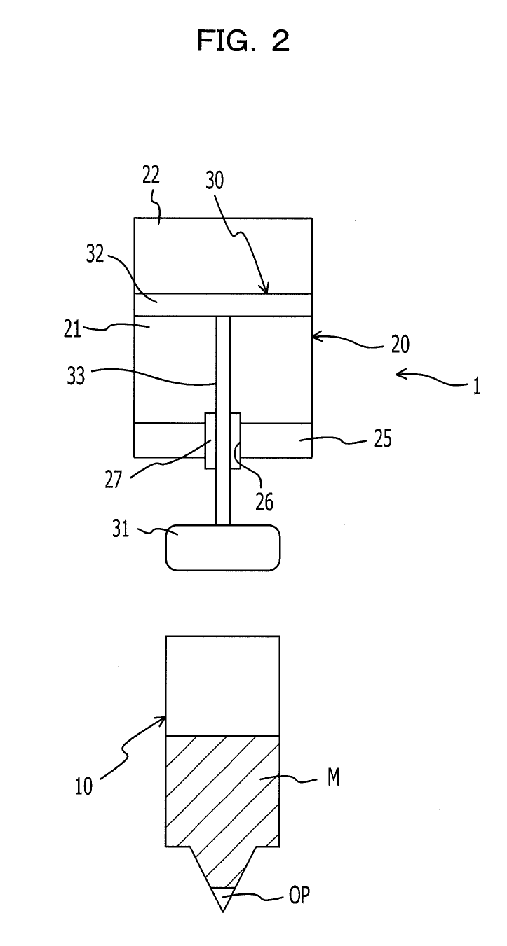

FIG. 2 illustrates an exemplary nozzle. The nozzle illustrated in FIG. 2 may be the nozzle illustrated in FIG. 1. The housing 10 may be filled with the application material M. For convenience of explanation, the nozzle 1 illustrated in FIG. 2 may be simplified. As illustrated in FIG. 2, the housing 10 may be capable of being removed from the housing 20. For example, a screw portion or the like may be provided for fitting the upper end of the housing 10 and the lower portion of the separation wall 25. The housing 10 rotates relative to the housing 20, and thus the housing 10 is removed from the housing 20. The piston 30 may be retained on the housing 20 side. For example, the housing 10 may be removed from the housing 20, and the application material M may be loaded into the housing 10. The housing of the nozzle 1 may include two housings 10 and 20 which are separable from each other, or may include a single housing. When the housing of the nozzle 1 includes a single housing, an opening which opens or closes, or the like, may be provided for loading the application material into the fill chamber.

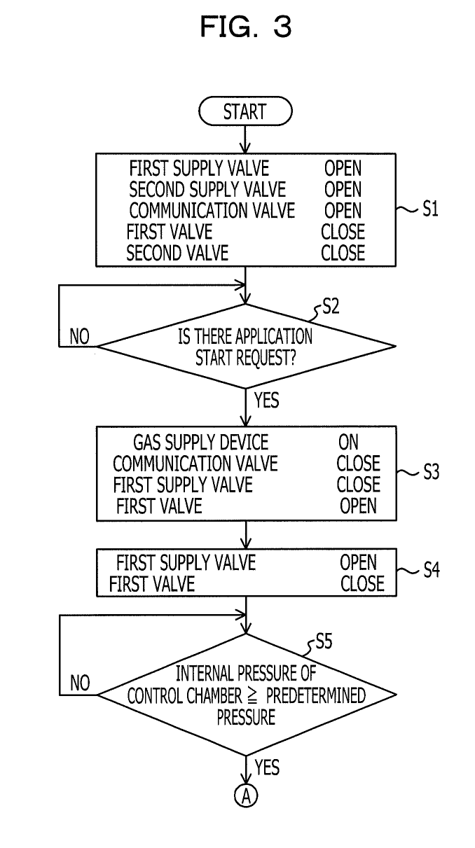

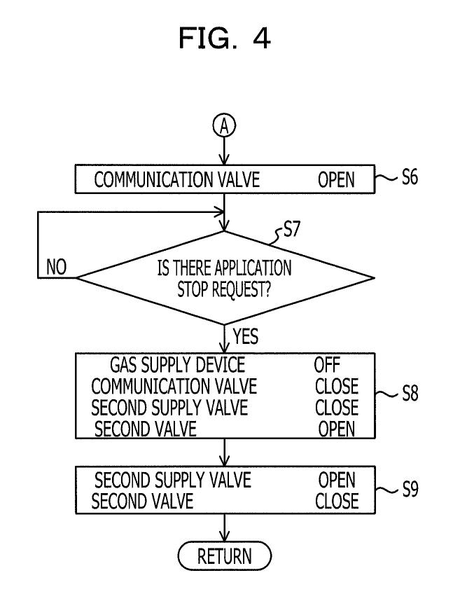

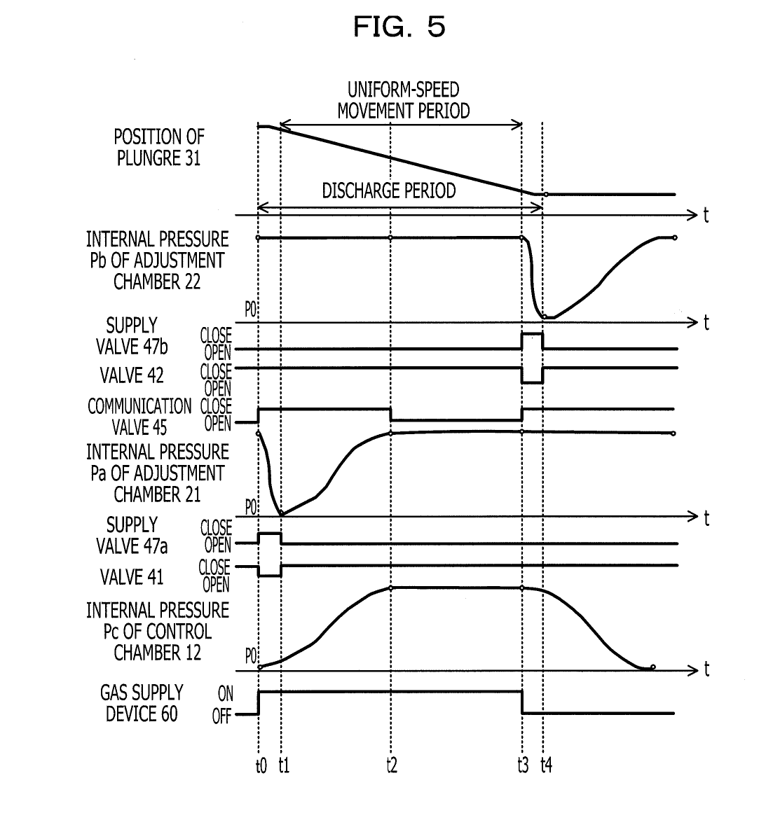

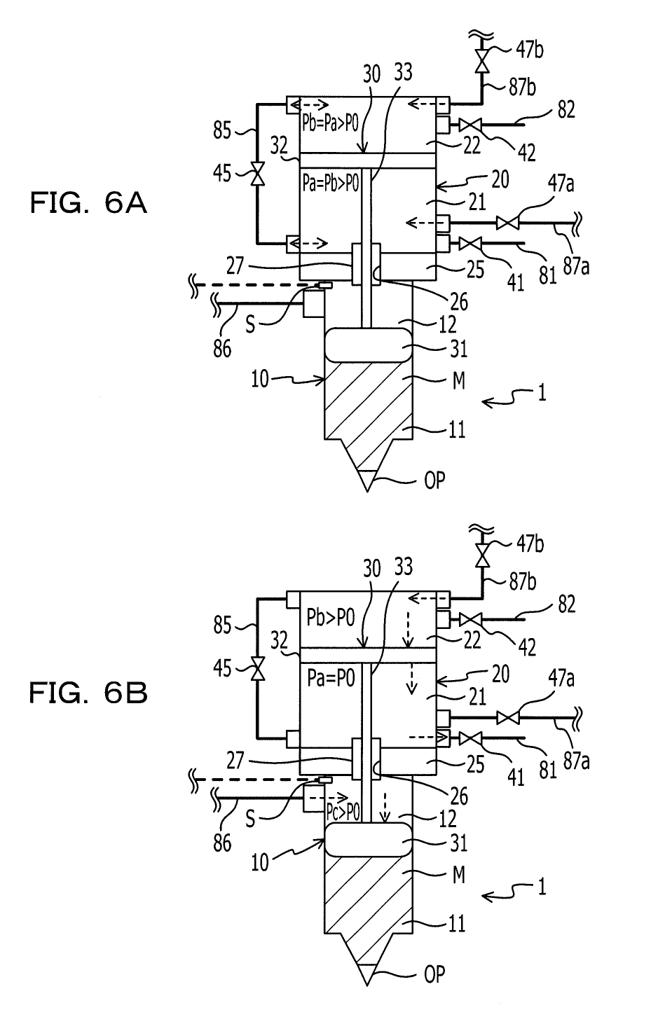

FIGS. 3 and 4 illustrate an exemplary operation of a controller. The controller illustrated in FIG. 1 may execute the operation illustrated in FIGS. 3 and 4. FIG. 5 illustrates an exemplary timing chart of a controller. FIG. 5 may be a timing chart of the controller illustrated in FIG. 1. In FIG. 5, the states of valves 41 and 42, the supply valves 47a and 47b, and the communication valve 45, the position of the plunger 31, the internal pressures of the adjustment chambers 21 and 22 and the control chamber 12, and the state of the gas supply device 60 are illustrated. FIGS. 6A and 6B, FIGS. 7A and 7B, and FIG. 8 illustrate an exemplary state of a nozzle. The nozzle illustrated in FIGS. 6A and 6B, FIGS. 7A and 7B, and FIG. 8 may be the nozzle illustrated in FIG. 1. In FIGS. 6A and 6B, FIGS. 7A and 7B, and FIG. 8, the internal pressures of the adjustment chambers 21 and 22 and the control chamber 12 are indicated as internal pressures Pa, Pb, and Pc, respectively.

As illustrated in FIG. 3, prior to start of application, in an operation S1, the controller 50 opens the supply valves 47a and 47b and the communication valve 45 and closes the valves 41 and 42. When the supply valves 47a and 47b open, air is supplied from the gas supply source 70 into the adjustment chambers 21 and 22, and thus the internal pressures Pa and Pb become greater than the atmospheric pressure P0. Since the communication valve 45 opens to provide communication between the adjustment chamber 21 and the adjustment chamber 22, the internal pressure Pa and the internal pressure Pb may become substantially the same.

In an operation S2, the controller 50 determines whether or not an application start request is present. When no application start request is present, the operation S2 is executed again. When an application start request is present, the controller 50 drives the gas supply device 60, closes the communication valve 45 and the supply valve 47a, and opens the valve 41, in an operation S3 illustrated in FIG. 3 or at timing t0 illustrated in FIG. 5.

Based on the driving of the gas supply device 60, air is supplied into the control chamber 12 and the internal pressure Pc becomes greater than the atmospheric pressure. Since the communication valve 45 closes, the communication between the adjustment chamber 21 and the adjustment chamber 22 is blocked and the internal pressure Pa of the adjustment chamber 21 and the internal pressure Pb of the adjustment chamber 22 are independently controlled. Since the supply valve 47a closes and the valve 41 opens in this state, the supply of air from the gas supply source 70 into the adjustment chamber 21 is stopped and the air within the adjustment chamber 21 is discharged to the outside of the adjustment chamber 21. As illustrated in FIG. 6B, at timing t1 illustrated in FIG. 5, the internal pressure Pa becomes substantially equal to the atmospheric pressure P0. The piston 30 starts moving to start application. The orders of the opening or closing timing of each valve and the driving timing of the gas supply device 60 in the operation S3 are arbitrary, and these timings may be substantially the same.

When the valves 41 and 42 close and each of the internal pressures of the adjustment chambers 21 and 22 exceeds the atmospheric pressure, the controller 50 opens the valve 41 and causes the gas supply device 60 to supply air into the control chamber 12, to cause the piston 30 to start moving. Since air is supplied into the control chamber 12 by the gas supply device 60, the internal pressure of the control chamber 12 increases to apply a downward force to the plunger 31. Since the valve 41 opens, the internal pressure Pa of the adjustment chamber 21 becomes substantially equal to the atmospheric pressure P0. Since the internal pressure Pb of the adjustment chamber 22 exceeds the atmospheric pressure, an internal pressure difference occurs between the adjustment chambers 21 and 22 after the valve 41 is opened. Due to the internal pressure difference between the adjustment chambers 21 and 22, a downward force is applied to the plunger 32. Based on the internal pressure of the control chamber 12 and the internal pressure difference between the adjustment chambers 21 and 22, the piston 30 starts moving.

As illustrated in FIG. 5, after the supply of air into the control chamber 12 is started by the gas supply device 60, the internal pressure Pc gradually increases. After a certain time period from the start of the supply of air into the control chamber 12, the internal pressure Pc reaches a desired pressure. When the piston 30 is driven based on the internal pressure Pc of the control chamber 12 without using an internal pressure difference between the adjustment chambers 21 and 22, the moving speed of the piston 30 gradually increases and the discharge amount of the application material also gradually increases. Immediately after the start of the application, a desired discharge amount of the application material may not be discharged.

Since the air within the adjustment chamber 21 is released to the outside of the adjustment chamber 21, an internal pressure difference occurs between the adjustment chambers 21 and 22. The piston 30 moves downward based on the internal pressure difference, and thus the responsiveness of the piston 30 at the start of movement may improve.

During a period from the time when the valve 41 opens to the time when the internal pressure Pc of the adjustment chamber 21 reaches the atmospheric pressure P0, for example, during a period from timing t0 to timing t1 illustrated in FIG. 5, the downward moving speed of the piston 30 increases. After the internal pressure Pc reaches the atmospheric pressure P0 at timing t1, the piston 30 moves downward at a substantially constant speed.

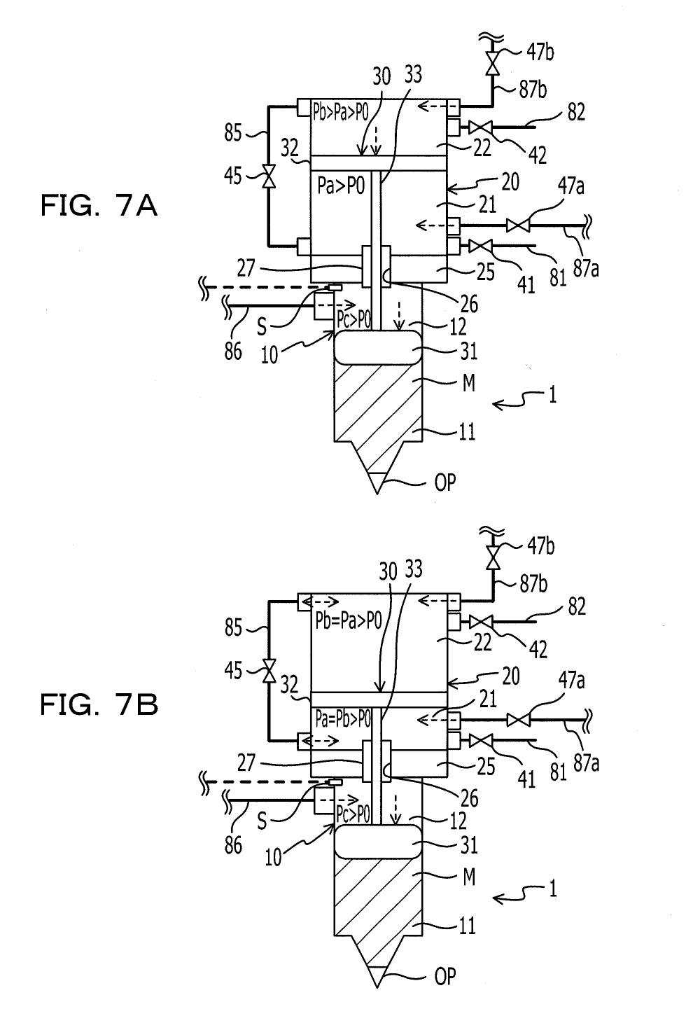

In an operation S4, the controller 50 opens the supply valve 47a and closes the valve 41 again at timing t1 illustrated in FIG. 5. Air is supplied from the gas supply source 70 into the adjustment chamber 21 again, and the internal pressure Pa of the adjustment chamber 21 increases from the atmospheric pressure, for example, as illustrated in FIG. 7A. During this period as well, air is supplied into the control chamber 12 by the gas supply device 60 and the internal pressure Pc increases.

During a period from the time when the valve 41 closes to the time when the communication valve 45 opens, for example, during a period from timing t1 to timing t2 illustrated in FIG. 5, the piston 30 moves downward at a substantially constant speed. During this period, the internal pressure Pc of the control chamber 12 gradually increases, and thus a downward force applied to the plunger 31 based on the internal pressure Pc of the control chamber 12 gradually increases. During this period, the internal pressure Pa of the adjustment chamber 21 increases and the internal pressure Pb of the adjustment chamber 22 is substantially constant, and thus the internal pressure difference between the adjustment chambers 21 and 22 decreases. Since the internal pressure difference between the adjustment chambers 21 and 22 decreases, a downward force applied to the plunger 32 gradually decreases. During the period from timing t1 to timing t2 illustrated in FIG. 5, the downward pressure applied to the plunger 31 increases and the downward pressure applied to the plunger 32 decreases. Thus, the downward pressure applied to the entirety of the piston 30 is substantially constant, and the piston 30 moves downward at a substantially constant speed.

In an operation S5 illustrated in FIG. 3, the controller 50 determines whether or not the internal pressure Pc of the control chamber 12 is equal to or greater than a given pressure, based on an output signal from the sensor S. When the internal pressure Pc is not equal to or greater than the given pressure, the controller 50 executes the operation S5 again. When the internal pressure Pc of the control chamber 12 is equal to or greater than the given pressure, the controller 50 opens the communication valve 45 at timing t2 illustrated in FIG. 5 in an operation S6. The given pressure means the internal pressure Pc in a stationary state where, due to the performance of the gas supply device 60, the internal pressure Pc does not increase further even when air is supplied into the control chamber 12. The given pressure may be previously calculated based on an experiment and may be stored in the ROM of the controller 50. The controller 50 determines whether or not to open the communication valve 45, in accordance with a detection signal from the sensor S. When the communication valve 45 is opened, communication between the adjustment chambers 21 and 22 is provided and the internal pressure Pa and the internal pressure Pb become substantially the same, as illustrated in FIG. 7B. In FIG. 5, the communication valve 45 is opened after the internal pressure Pa increases to be substantially the same as the internal pressure Pb. For example, before the internal pressure Pc of the control chamber 12 becomes equal to or greater than the given pressure and the internal pressure Pa and the internal pressure Pb become substantially the same, the communication valve 45 may open.

During a period when the communication valve 45 opens, for example, during a period from timing t2 to timing t3 illustrated in FIG. 5, the supply of air from the gas supply device 60 into the control chamber 12 is continued and the piston 30 continues to move downward. During the period when the communication valve 45 opens, the internal pressure Pa of the adjustment chamber 21 and the internal pressure Pb of the adjustment chamber 22 may be substantially the same. The upward force applied to the plunger 32 by the internal pressure Pa and the downward force applied to the plunger 32 by the internal pressure Pb may be balanced. The internal pressures Pa and Pb may not act so as to disturb the downward movement of the piston 30 and may not act so as to prompt the downward movement of the piston 30. Thus, during the period when the communication valve 45 opens, the piston 30 continues to move downward based on the internal pressure Pc of the control chamber 12. The supply of air from the gas supply device 60 into the control chamber 12 is continued but the internal pressure Pc is kept at a stationary value. Discharge of the application material M is continued.

The communication valve 45 closes at the start of movement of the piston 30 and opens during movement of the piston 30. When the communication valve 45 opens, the internal pressure difference between the adjustment chambers 21 and 22 may be substantially zero. When the communication valve 45 opens, the piston 30 may move based on the internal pressure Pc of the control chamber 12 during movement of the piston 30.

When the internal pressure Pc reaches the stationary value, for example, when the internal pressure Pc is kept at a constant value, the communication valve 45 opens. Thus, the piston 30 moves downward based on the action of the internal pressure Pc which is kept at the constant value. As a result, the piston 30 moves downward at a substantially constant speed.

For example, when the communication valve 45 is closed, air is supplied into the adjustment chambers 21 and 22, and the internal pressure difference between the adjustment chambers 21 and 22 varies even when the internal pressure Pc is at the stationary value, the piston 30 may not move at a substantially constant speed, due to the variation of the internal pressure difference. Since the communication valve 45 is opened when it is detected that the internal pressure Pc reaches the stationary value, the internal pressure difference between the adjustment chambers 21 and 22 becomes zero, and the piston 30 moves downward at a substantially constant speed based on the internal pressure Pc. Thus, the discharge amount of the application material M may be kept substantially constant.

In an operation S7, the controller 50 determines whether or not an application stop request is present. When no application stop request is present, the controller 50 executes the operation S6. When an application stop request is present, the controller 50 stops the gas supply device 60, closes the communication valve 45 and the supply valve 47b, and opens the valve 42, at timing t3 illustrated in FIG. 5 in an operation S8.

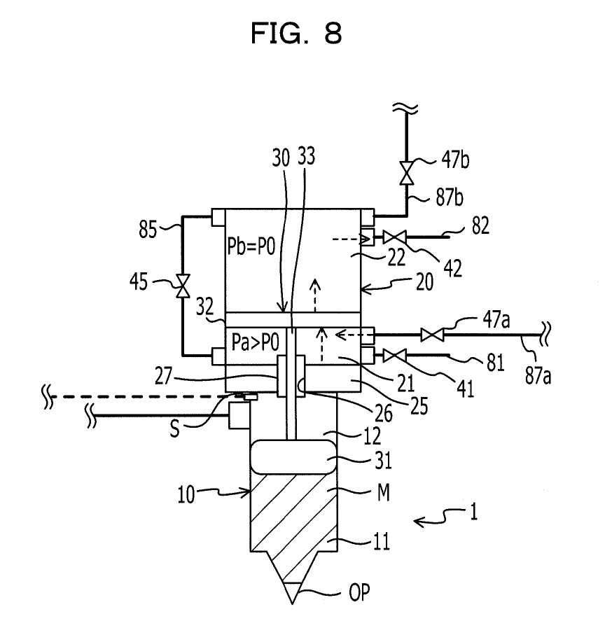

Since the gas supply device 60 stops, the internal pressure Pc of the control chamber 12 gradually decreases toward the atmospheric pressure PO as illustrated in FIG. 5. Since the communication valve 45 closes, the internal pressure Pa of the adjustment chamber 21 and the internal pressure Pb of the adjustment chamber 22 may be independently controlled. Since the supply valve 47b closes and the valve 42 opens in this state, the supply of air from the gas supply source 70 into the adjustment chamber 22 is stopped and the air within the adjustment chamber 22 is released to the outside of the adjustment chamber 22. As illustrated in FIG. 8, the internal pressure Pb becomes substantially equal to the atmospheric pressure P0, for example, at timing t4 illustrated in FIG. 5. The orders of the opening or closing timing of each valve and the driving timing of the gas supply device 60 in the operation S7 may be arbitrary, and these timings may be substantially the same.

When the valves 41 and 42 close and the gas supply device 60 supplies air into the control chamber 12 in order for each of the internal pressures of the adjustment chambers 21 and 22 to exceed the atmospheric pressure, the controller 50 opens the valve 42 and stops the supply of air from the gas supply device 60 into the control chamber 12 to stop the piston 30. Since the valve 42 opens, the internal pressure Pb of the adjustment chamber 22 becomes substantially equal to the atmospheric pressure P0. The internal pressure Pa of the adjustment chamber 21 is kept greater than the atmospheric pressure, and thus an internal pressure difference occurs between adjustment chambers 21 and 22 when the valve 42 opens. Based on the internal pressure difference between the adjustment chambers 21 and 22, an upward force is applied to the plunger 32 and the downward movement of the piston 30 may be immediately stopped.

As illustrated in FIG. 5, after the gas supply device 60 stops, the internal pressure Pc gradually decreases and reaches the atmospheric pressure P0. Thus, after a certain time period from the time when the supply of air into the control chamber 12 stops, the internal pressure Pc returns to the atmospheric pressure PO. When the gas supply device 60 stops without using an internal pressure difference between the adjustment chambers 21 and 22, the moving speed of the piston 30 gradually decreases and the discharge amount of the application material also gradually decreases during the certain time period. Then, the discharge of the application material stops. At end of the application as well, the discharge of the application material M may not immediately stop.

Since the air within the adjustment chamber 22 is released to the outside of the adjustment chamber 22, an internal pressure difference occurs between the adjustment chambers 21 and 22. The downward movement of the piston 30 stops based on the internal pressure difference. The responsiveness of the piston 30 at the stop may improve.

As illustrated in FIG. 5, in reality, during a period from the time when the valve 42 opens to the time when the internal pressure Pb of the adjustment chamber 22 reaches the atmospheric pressure P0, the downward moving speed of the piston 30 gradually decreases, and the piston 30 stops substantially simultaneously with the time when the internal pressure Pb reaches the atmospheric pressure P0 at timing t4.

Since the controller 50 closes the communication valve 45 to stop the piston 30, the communication valve 45 opens during movement of the piston 30 and closes at stop of the piston 30. In an operation S9, the controller 50 opens the supply valve 47b and closes the valve 42. Thus, the internal pressure Pb of the adjustment chamber 22 increases and the internal pressure Pb and the internal pressure Pa become substantially the same.

During a period from the time when the valve 41 opens and the internal pressure Pa reaches the atmospheric pressure PO to the time when the valve 42 opens, for example, during a period from timing t1 to timing t3 illustrated in FIG. 5, the piston 30 moves downward at a substantially constant speed. A period when the application material M is discharged is a period from the start of the application to the time when the piston 30 completely stops, for example, a period from timing t0 to timing t4 illustrated in FIG. 5. Through the above process, the controller 50 drives the piston 30.

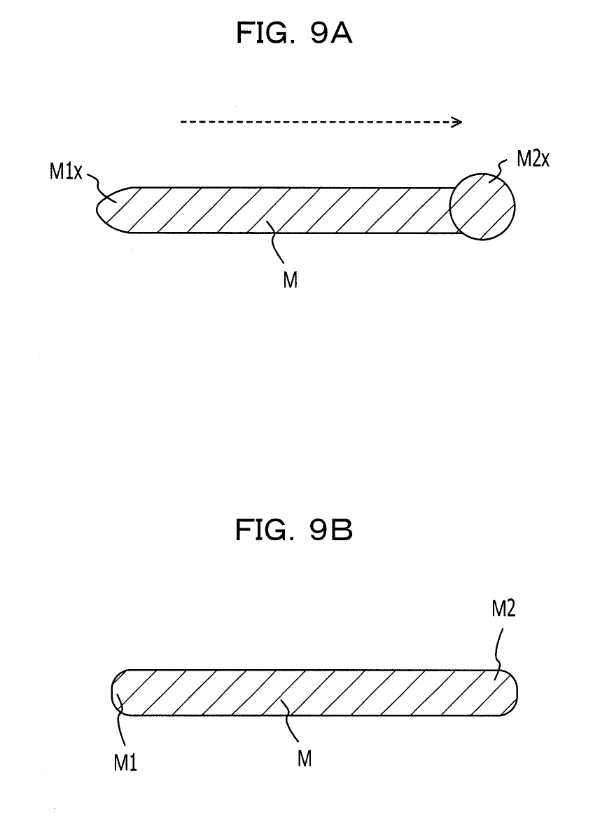

FIGS. 9A and 9B illustrate an exemplary discharge state of an application material. FIGS. 9A and 9B illustrate, for example, a discharge state of the application material M when the nozzle 1 illustrated in FIG. 1 moves horizontally rightward at a constant speed. FIGS. 9A and 9B illustrate the application material M applied onto a certain member. For example, FIG. 9A illustrates a discharge state of the application material M when the piston 30 is driven based on the internal pressure of the control chamber 12 illustrated in FIG. 1. For example, FIG. 9B illustrates a discharge state of the application material M when the piston 30 is driven based on the internal pressure of the control chamber 12 illustrated in FIG. 1 and the internal pressure difference between the adjustment chambers 21 and 22.

When the internal pressure of the control chamber 12 is used, the responsiveness of the piston 30 may decrease. Thus, as illustrated in FIG. 9A, the discharge amount of the application material M decreases at an end M1x of the application material M corresponding to a start position of the application. As the nozzle 1 moves horizontally rightward, the discharge amount of the application material M becomes constant. When the horizontally rightward movement of the nozzle 1 stops at an end position of the application, supply of air from the gas supply device 60 into the control chamber 12 stops. Thus, the discharge amount increases at another end M2x corresponding to the end position of the application. When the supply of air from the gas supply device 60 into the control chamber 12 stops, the piston 30 does not immediately stop. Thus, at the other end M2x, the application material M may be discharged in an amount larger than a desired discharge amount.

When the piston 30 is driven based on the internal pressure of the control chamber 12 and the internal pressure difference between the adjustment chambers 21 and 22, the responsiveness of the piston 30 may improve. Thus, as illustrated in FIG. 9B, the discharge amount of the application material M is kept constant even at an end M1 and another end M2. Further, since movement of the piston 30 is controlled with air pressure, the weight of the nozzle 1 may be reduced to be less than that when an actuator such as a motor is used. As a result, when the nozzle 1 is retained and moved by a robot, it is made possible to control the nozzle 1 at a high speed and with high accuracy.

A reference for control of the pressure in the adjustment chamber may be the atmospheric pressure PO or may be a given pressure other than the atmospheric pressure.

In the operations S4 and S5 illustrated in FIG. 3, the controller 50 opens the communication valve 45 when the internal pressure of the adjustment chamber 21 becomes equal to or greater than the given pressure based on a detection signal from the sensor S. For example, the controller 50 may open the communication valve 45 when a change amount of the internal pressure of the adjustment chamber 21 becomes equal to or less than a given value based on a detection signal from the sensor S. For example, when the sensor S detects a stationary state where the internal pressure of the adjustment chamber 21 is constant, the communication valve 45 may open. The controller 50 may control opening and closing of the communication valve 45 in accordance with a detection signal from the sensor S.

For example, a single device which supplies air into the control chamber 12 and the adjustment chambers 21 and 22 may be used instead of the gas supply device 60 and the gas supply source 70. Since the internal pressure of the control chamber 12 and the internal pressure of the fill chamber 11 become substantially equal to each other, the sensor S may detect the internal pressure of the fill chamber 11.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An application apparatus comprising:
a piston including a first plunger and a second plunger that are fixed to a shaft;
a housing including a fill chamber having an outlet, a control chamber separated from the fill chamber by the first plunger, first and second adjustment chambers separated from each other by the second plunger, and a separation section that separates the control chamber and the first adjustment chamber, the shaft extending moveably through the separation section;
a gas supply section to supply a gas into the control chamber, the first adjustment chamber, and the second adjustment chamber;
a first valve to control release of the gas within the first adjustment chamber;
a second valve to control release of the gas within the second adjustment chamber; and
a control section to close the first valve and the second valve and open the first valve to supply the gas into the control chamber and move the piston.

2. The application apparatus according to claim 1, wherein the control section opens the first valve in a state where each of internal pressures of the first adjustment chamber and the second adjustment chamber exceeds a given pressure.

3. The application apparatus according to claim 1, further comprising, a communication valve to communicate between the first adjustment chamber and the second adjustment chamber.

4. The application apparatus according to claim 3, wherein the control section closes the communication valve at start of movement of the piston, and opens the communication valve during movement of the piston.

5. The application apparatus according to claim 3, further comprising, a sensor to output a detection signal corresponding to an internal pressure of the fill chamber or the control chamber, wherein the control section controls opening and closing of the communication valve in accordance with the detection signal.

6. The application apparatus according to claim 1, further comprising:
a first supply valve to switch a communication state between the gas supply section and the first adjustment chamber; and
a second supply valve to switch a communication state between the gas supply section and the second adjustment chamber.

7. The application apparatus according to claim 6, wherein the control section closes the first supply valve while the first valve opens, and the control section closes the second supply valve while the second valve opens.

8. An application apparatus comprising:
a piston including a first plunger and a second plunger that are fixed to a shaft;
a housing including a fill chamber having an outlet, a control chamber separated from the fill chamber by the first plunger, first and second adjustment chambers separated from each other by the second plunger, and a separation section that separates the control chamber and the first adjustment chamber, the shaft extending moveably through the separation section;
a gas supply section to supply a gas into the control chamber, the first adjustment chamber, and the second adjustment chamber;
a first valve to control release of the gas within the first adjustment chamber;
a second valve to control release of the gas within the second adjustment chamber; and
a control section to close the first valve and the second valve and open the second valve to stop supply of the gas into the control chamber and stop the piston.

9. The application apparatus according to claim 8, wherein the second valve is opened in a state where each of internal pressures of the first adjustment chamber and the second adjustment chamber exceeds a given pressure and the gas supply section supplies the gas into the control chamber.

10. The application apparatus according to claim 9, further comprising, a communication valve being capable of communicating between the first adjustment chamber and the second adjustment chamber.

11. The application apparatus according to claim 10, wherein the control section opens the communication valve at start of movement of the piston, and closes the communication valve during stop of the piston.

12. The application apparatus according to claim 10, further comprising, a sensor to output a detection signal corresponding to the internal pressure of the fill chamber or the control chamber, wherein the control section controls opening and closing of the communication valve in accordance with the detection signal.

13. The application apparatus according to claim 8, further comprising:
a first supply valve to switch a communication state between the gas supply section and the first adjustment chamber; and
a second supply valve to switch a communication state between the gas supply section and the second adjustment chamber.

14. The application apparatus according to claim 13, wherein the control section closes the first supply valve while the first valve opens, and the control section closes the second supply valve while the second valve opens.
